(19) United States
(12) Patent Application Publication
(10) Pub. No.: US 2014/0252910 A1
(43) Pub. Date: Sep. 11, 2014

(54) INDUCTION MACHINE

(71) Applicant: Hitachi, Ltd., Tokyo (JP)

(72) Inventors: Naoki KUNIHIRO, Tokyo (JP); Kazuo NISHIHAMA, Tokyo (JP); Motonobu IIZUKA, Tokyo (JP); Kenichi SUGIMOTO, Tokyo (JP); Masanori SAWAHATA, Tokyo (JP); Akiyoshi KOMURA, Tokyo (JP)

(73) Assignee: Hitachi, Ltd., Tokyo (JP)

(21) Appl. No.: 14/198,843

(22) Filed: Mar. 6, 2014

(30) Foreign Application Priority Data
Mar. 6, 2013 (JP) 2013-043724

(51) Int. Cl. H02K 17/16

(52) U.S. Cl. CPC H02K 17/165
USPC 310/211

(57) ABSTRACT

There is provided an induction machine having a squirrel-cage rotor, the rotor including: a rotor core; a plurality of rotor slots formed on the rotor core and aligned circumferentially at a predetermined interval; a plurality of rotor bars inserted into one of the plurality of rotor slots; and a plurality of rotor slits formed adjacent to the plurality of rotor slots on an outer circumferential side of the rotor core. The each rotor slit is formed as a hollow such that a cross sectional shape thereof is distinguished into three parts of a slit outer circumferential part, a slit intermediate part, and a slit inner circumferential part. A circumferential width of the each rotor slit on an innermost circumferential side is larger than that on an outermost circumferential side. A circumferential width of the slit intermediate part increases from an outer circumferential side toward an inner circumferential side.

### CLAIM OF PRIORITY

The present application claims priority from Japanese patent application serial no. 2013-043724 filed on Mar. 6, 2013, the content of which is hereby incorporated by reference into this application.

### BACKGROUND OF THE INVENTION

1. Field of the Invention

The present invention relates to an induction machine such as an induction motor or an induction generator, and particularly to an induction machine having a structure that can reduce a copper loss generated in a rotor conductor.

2. Description of Related Art

Induction machines are being used in many industrial fields. In these years, as a social tendency, there is a need for an induction machine that satisfies a demand for energy conservation and resource conservation. To respond to this requirement, many improved technologies have been proposed to increase the efficiency of the induction machines.

It is known that the induction machine generates a harmonic magnetic flux due to slot permeance pulsation or a magnetomotive force distribution and that a loss is thereby increased.

In order to reduce this loss caused by a harmonic magnetic flux, for example, pre-grant publication 1 (JP 2011-087373 A) proposes that a rotor conductor is placed close to the center of a rotor slot, thereby reducing an electric power loss.

Also, pre-grant publication 2 (JP 2012-085477 A) proposes that a rotor slot is shaped so as to be asymmetric in its circumferential direction with respect to an axis that extends from the central axis of a rotor in a radial direction, thereby reducing the harmonic loss and improve the power factor.

Furthermore, pre-grant publication (JP Hei 4 (1995)-284254 A), non-patent issue 1 (Katayama Ed., “Yudoki”) and non-patent issue 2 (Ichiki at al. Trans., “Denki Kikai Genron”) disclose that the width of a rotor slit is increased from the outer circumference side toward the inner circumference side.
[Non-Patent Issue 1]
Katayama Ed., “Yudoki” NIKKAN KOGYO SHIMBUN, Ltd., Nov. 27, 1965, first edition, p. 79 (FIG. 3.24).
[Non-patent Issue 2]
Ichiki et al. Trans., “Denki Kikai Genron” CORONA PUBLISHING Co., Ltd., 1967, p. 287 (FIG. 244).

Pre-grant publications 1-3 mentioned above propose methods which are effective in solving their respective problems. In pre-grant publication 1, for example, the electric power loss can be improved. In pre-grant publication 2, the power factor can be improved. However, in pre-grant publications 1-3, if one of these effects is provided, the other effect has to be sacrificed; both reduction in electric power loss and improvement of the power factor are not achieved.

### SUMMARY OF THE INVENTION

In view of foregoing, it is an objective of the present invention to provide an induction machine which can improve the power factor and can increase the efficiency by reducing the leakage flux of a main magnetic flux and increasing the leakage flux of a harmonic component.

(I) According to one aspect of the present invention, there is provided an induction machine including a squirrel-cage rotor, the squirrel-cage rotor comprising: a rotor core; a plurality of rotor slots, each of the rotor slots being formed on the rotor core so as to extend along an axial direction of the rotor core and being aligned in a circumferential direction of the rotor core at a predetermined interval on an outer circumferential side of the rotor core; a plurality of rotor bars, each of the rotor bars being inserted into one of the plurality of rotor slots; and a plurality of rotor slits formed adjacent to the plurality of rotor slots in a redial direction of the rotor core, the plurality of rotor slits being closer to an outer circumference of the rotor core than the plurality of rotor slots being. Each of the rotor slits is formed as a hollow. Each of the rotor slits has a region in which a width in the circumferential direction (a circumferential width) of the region increases from an outer circumferential side toward an inner circumferential side. A width in the circumferential direction (a circumferential width) of the each rotor slit on an innermost circumferential side is larger than that of the each rotor slit on an outermost circumferential side, and is smaller than a width in the circumferential direction (a circumferential width) of an outermost circumferential surface of each of the rotor bars.

(II) According to another aspect of the invention, there is provided an induction machine including a squirrel-cage rotor, the squirrel-cage rotor comprising: a rotor core; a plurality of rotor slots, each of the rotor slots being formed on the rotor core so as to extend along an axial direction of the rotor core and being aligned in a circumferential direction of the rotor core at a predetermined interval on an outer circumferential side of the rotor core; a plurality of rotor bars, each of the rotor bars being inserted into one of the plurality of rotor slots; and a plurality of rotor slits formed adjacent to the plurality of rotor slots in a redial direction of the rotor core, the plurality of rotor slits being closer to an outer circumference of the rotor core than the plurality of rotor slots being. Each of the rotor slits is formed as a hollow. Each of the rotor slits has a region in which a width in the circumferential direction (a circumferential width) of the region increases from an outer circumferential side toward an inner circumferential side. A width in the circumferential direction (a circumferential width) of the each rotor slit on an innermost circumferential side is larger than that of the each rotor slit on an outermost circumferential side, and is larger than a width in the circumferential direction (a circumferential width) of an outermost circumferential surface of each of the rotor bars. At least one fitting portion to hold the rotor bar is formed on each of the rotor slot.

In the above aspects (I) and (II) of the invention, the following modifications and changes can be made.

(i) The each rotor slit has another region in which an increase rate in a width in the circumferential direction of the another region along the radial direction becomes small, the another region following the region in which the width in the circumferential direction of the region increases from the outer circumferential side toward the inner circumferential side.

(ii) The width of the outermost circumferential surface of the each rotor bar is larger than a width of an innermost circumferential surface of the each rotor bar.

(iii) A width in the circumferential direction of the rotor core sandwiched between two adjacent rotor slots is constant from the outer circumference side toward outer the inner circumference side.

(iv) A slit opening formed in the each rotor slit, the slit opening being positioned at an outermost circumference of the each rotor slit, is shifted toward a delayed side in a rotational direction of the rotor within the width of the outermost circumferential surface of the each rotor bar.

(v) A slit opening formed in the each rotor slit, the slit opening being positioned at an outermost circumference of the each rotor slit, is shifted toward a delayed side in a rotational direction of the rotor; and a delayed side in the rotational direction of the slit opening is positioned toward the delayed side beyond the width of the outermost circumferential surface of the each rotor bar.

(vi) The induction machine is applied to a drilling system that has a drill for which a driving force on one direction is required.

(vii) The induction machine is driven by a voltage supplied from an AC power supply or a DC power supply, the voltage being converted by an inverter or a converter before being supplied to the induction machine.

(III) According to still another aspect of the invention, there is provided an induction machine including a squirrel-cage rotor, the squirrel-cage rotor comprising: a rotor core; a plurality of rotor slots, each of the rotor slots being formed on the rotor core so as to extend along an axial direction of the rotor core and being aligned in a circumferential direction of the rotor core at a predetermined interval on an outer circumferential side of the rotor core; a plurality of rotor bars, each of the rotor bars being inserted into one of the plurality of rotor slots; and a plurality of rotor slits formed adjacent to the plurality of rotor slots in a redial direction of the rotor core, the plurality of rotor slits being closer to an outer circumference of the rotor core than the plurality of rotor slots being. Each of the rotor slits is formed as a hollow. Each of the rotor slits is formed such that a cross sectional shape thereof is distinguished into three parts of: a slit outer circumferential part positioned at an outermost circumference of the rotor core, in which a slit opening is formed; a slit intermediate part adjacent to the slit outer circumferential part, in which a width in the circumferential direction (a circumferential width) of the each rotor slit increases from an outer circumference side toward an inner circumference side; and a slit inner circumferential part adjacent to the slit intermediate part, in which an increase rate in the width in the circumferential direction (the circumferential width) along the radial direction of the slit inner circumferential part is smaller than that of the slit inner circumferential part.

In the above aspect (III) of the invention, the following modifications and changes can be made.

(viii) Denoting a width in the circumferential direction of the slit opening in the slit outer circumferential part as S2, denoting a width in the circumferential direction of the slit inner circumferential part at an innermost circumferential position as W, and denoting an angle of the slit intermediate part with respect to the circumferential direction as θ, a relationship between S2 and W is S2/W≦0.3, and θ≧11°.

(ix) Denoting a width in the circumferential direction of the slit opening in the slit outer circumferential part as S2, denoting a width in the circumferential direction of the slit inner circumferential part at an innermost circumferential position as W, and denoting an angle of the slit intermediate part with respect to the circumferential direction as θ, a relationship between S2 and W is S2/W≦0.3, and θ≧12°.

(x) Denoting a width in the circumferential direction of the slit opening in the slit outer circumferential part as S2, denoting a width in the circumferential direction of the slit inner circumferential part at an innermost circumferential position as W, and denoting a height in the radial direction of the slit inner circumferential part as β, a relationship between S2 and W is S2/W≦0.3, and a relationship between β and W is β/W≦0.21.

(xi) Denoting a width in the circumferential direction of the slit opening in the slit outer circumferential part as S2, denoting a width in the circumferential direction of the slit inner circumferential part at an innermost circumferential position as W, denoting a height in the radial direction of the each rotor slit as H, and denoting an area of the each rotor slit as S, a relationship between S2 and W is S2/W≦0.3, and a relationship between H and S is H²/S≧0.65.

(xii) Denoting a width in the circumferential direction of the slit opening in the slit outer circumferential part as S2, denoting a width in the circumferential direction of the slit inner circumferential part at an innermost circumferential position as W, denoting a height in the radial direction of the each rotor slit as H, and denoting an area of the each rotor slit as S, a relationship between S2 and W is S2/W≦0.3, and a relationship between H and S is H²/S≦1.80.

(xiii) Denoting a height in the radial direction of the slit inner circumferential part as β, denoting a width in the circumferential direction of the slit inner circumferential part at an innermost circumferential position as W, and denoting an angle of the slit intermediate part with respect to the circumferential direction as θ, a relationship between β and W is β/W≧0.21, and θ≧11°.

(xiv) Denoting a height in the radial direction of the slit inner circumferential part as β, denoting a width in the circumferential direction of the slit inner circumferential part at an innermost circumferential position as W, denoting an angle of the slit intermediate part with respect to the circumferential direction as θ, denoting a height in the radial direction of the each rotor slit as H, and denoting an area of the each rotor slit as S, a relationship between β and W is β/W≧0.21, θ≧11°, and a relationship between H and S is 0.65≦H²/S≦1.80.

(xv) The induction machine is driven by a voltage supplied from an AC power supply or a DC power supply, the voltage being converted by an inverter or a converter before being supplied to the induction machine.

### Advantages of the Invention

According to the present invention, it is possible to provide an induction machine that improves the power factor and increases the efficiency by reducing the leakage flux of a main magnetic flux and increasing the leakage flux of a harmonic component.

### BRIEF DESCRIPTION OF THE DRAWINGS

FIG. 1 is schematic drawings showing a longitudinal sectional view in the axial direction of a squirrel-cage induction machine, an upper half portion, according to a first embodiment of the present invention and an enlarged cross sectional view thereof taken along line A-A;

FIG. 2 is a graph showing a relationship between a flux pulsation ratio and a ratio of a stator slot opening width to a gap length between a stator and a rotor;

FIG. 3 is a graph showing a relationship between the rotor Carter coefficient and a ratio of a rotor slit width to a gap length between a stator and a rotor;

FIG. 4 is a schematic drawing showing an enlarged cross sectional view around a rotor slot, in which a case (solid lines) provided with a slit inner circumferential part and another case (broken lines) without the slit inner circumferential part are illustrated;

FIG. 5A is a schematic drawing showing an enlarged cross sectional view around a rotor slot, in which a variation of a rotor slit shape is illustrated;

FIG. 5B is a schematic drawing showing an enlarged cross sectional view around a rotor slot, in which another variation of the rotor slit shape is illustrated;

FIG. 6 shows, in tabular form, a relationship between structure/configuration of each part of the rotor slit and an advantageous effect achieved by the each part;

FIG. 7 is a schematic drawing showing an enlarged cross sectional view around a rotor slot of a squirrel-cage induction machine according to a second embodiment of the present invention;

FIG. 8 shows an efficiency map of the induction machine for dimensions defined in FIG. 7;

FIG. 9 is a schematic drawing showing an enlarged cross sectional view around rotor slots, in which different harmonic magnetic flux paths at different heights of a slit inner circumferential part are illustrated;

FIG. 10 is a graph showing a relationship between a magnetic flux density of the outer circumferential part of a rotor core and an inclination angle of a slit intermediate part, in which a DC magnetization curve of an electromagnetic steel sheet is also illustrated;

FIG. 11 is a schematic drawing showing an enlarged cross sectional view around a rotor slot of an induction machine according to a third embodiment of the present invention;

FIG. 12 is a graph showing a relationship between an inclination angle θ₂ and a ratio of a stress due to a centrifugal force on a portion h to a yield stress of an electromagnetic steel configuring a rotor core;

FIG. 13 is a schematic drawing showing an enlarged cross sectional view around a rotor slot of an induction machine according to a fourth embodiment of the present invention;

FIG. 14 is a schematic drawing showing an enlarged cross sectional view around a rotor slot of an induction machine according to a fifth embodiment of the present invention;

FIG. 15 is a schematic drawing showing an enlarged cross sectional view around a rotor slot of an induction machine according to a sixth embodiment of the present invention;

FIG. 16A is a schematic drawing showing an exemplary enlarged cross sectional view around a rotor slot of an induction machine according to a seventh embodiment of the present invention;

FIG. 16B is a schematic drawing showing another exemplary enlarged cross sectional view around a rotor slot of the induction machine according to the seventh embodiment;

FIG. 16C is a schematic drawing showing another exemplary enlarged cross sectional view around a rotor slot of the induction machine according to the seventh embodiment; and

FIG. 17 is a schematic drawing showing an example of an induction machine driving system according to the present invention, accompanying with schematic drawings of a longitudinal sectional view in the axial direction of an induction machine and an enlarged cross sectional view thereof taken along line A-A′.

### DETAILED DESCRIPTION OF THE PREFERRED EMBODIMENTS

Preferred embodiments of the present invention will be described below in detail with reference to the accompanying drawings. However, the invention is not limited to the specific embodiments described below, but various combinations and modifications are possible without departing from the spirit and scope of the invention. In these embodiments, like elements or elements having like functions will be denoted by like reference numerals and repeated descriptions will be omitted. Descriptions below will mainly focus on different points.

### First Embodiment

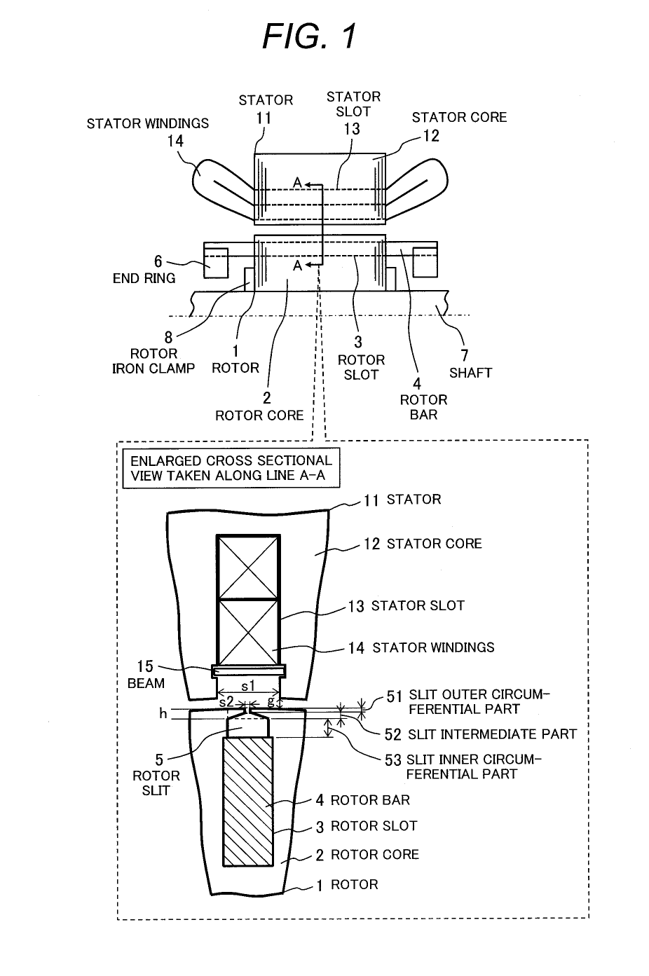

FIG. 1 is schematic drawings showing a longitudinal sectional view in the axial direction of a squirrel-cage induction machine, an upper half portion, according to a first embodiment of the present invention and an enlarged cross sectional view thereof taken along line A-A. As indicated in the schematic drawings of FIG. 1, the squirrel-cage induction machine includes a shaft 7, a rotor 1 secured to the shaft 7, a stator 11 that faces the rotor 1 with a gap left therebetween, and other elements.

Furthermore, the stator 11 has a plurality of stator slots 13, which are placed in its circumferential direction at a predetermined interval, in an inner circumferential part, each rotor slot 13 being formed continuously in its axial direction. The stator 11 also has a stator core 12, which is formed by laminating a plurality of thin steel sheets such as electromagnetic steel sheets in its axial direction, and stator windings 14 loaded in the plurality of stator slots 13.

The rotor 1 is placed coaxially with the stator 11 on the inner circumferential side of the stator 11 with a predetermined gap left in the radial direction between the rotor 1 and the stator 11. The rotor 1 has a plurality of rotor slots 3 placed in its circumferential direction at a predetermined interval in its outer circumferential part, each rotor slot 3 being continuously formed in its axial direction. The rotor 1 also has a rotor core 2, which is formed by laminating a plurality of thin steel plates, such as electromagnetic steel sheets, in the axial direction.

Furthermore, the rotor 1 has: a plurality of rotor bars 4 made of copper, each of which extends in its axial direction and is inserted into one of the plurality of rotor slots 3; an end ring 6, which is a circular copper conductor that is disposed at both ends of the rotor core 2 to electrically connect the plurality of rotor bars 4 by soldering the outer circumferential part of the end ring 6 and the ends of the rotor bars 4; a shaft 7 disposed on the inner circumferential side of the rotor core 2, the longitudinal direction of the shaft 7 being the axial direction; and a rotor core clamps 8 disposed on both end surfaces of the rotor core 2.

FIG. 1 also shows a positional relationship between the stator 11 and the rotor 1 in detail in the enlarged cross sectional view taken along line A-A. In this detailed structure, the stator slot 13 is an open slot in which the stator winding 14 is secured to the stator core 12 by a beam 15 fitted to a groove in the stator slot 13.

With respect to the rotor 1, a plurality of rotor slits 5 are formed adjacent to the plurality of rotor slots 3, the plurality of rotor slits 5 being closer to the outer circumference of the rotor core 2 than the plurality of rotor slots 3 being. Each of the rotor slits 5 is formed as a hollow. The rotor slit 5 is formed so that its shape in the cross section is distinguished into three parts of a slit inner circumferential part 53 in contact with the outer circumferential surface of the rotor bar 4, a slit outer circumferential part 51 facing the stator 11, and a slit intermediate part 52 disposed between the slit inner circumferential part 53 and the slit outer circumferential part 51.

Differences in the shapes of the different parts of the rotor slit 5 will now be compared from the viewpoint of their widths in the circumferential direction. The width of the inner circumferential region of the rotor slit 5 (slit inner circumferential part 53) in the circumferential direction is larger than the width of the outer circumferential region of the rotor slit 5 (slit outer circumferential part 51) in the circumferential direction and is smaller than the width of the outer circumferential surface of the rotor bar 4 in the circumferential direction. The width of the slit intermediate part 52 of the rotor slit 5 in the circumferential direction increases gradually from the outer side toward the inner side in the radial direction of the rotor slit 5. In addition, the rotor slit 5 may have a portion, other than the slit outer circumferential part 51, in which an increase rate in the width of the rotor slit 5 in the circumferential direction along the radial direction becomes small. Details will be described later.

Since the width of the slit inner circumferential part 53 is smaller than the width of the rotor bar 4, a stepped support part that secures the rotor bar 4 is formed between the slit inner circumferential part 53 and the rotor bar 4. As described above, when the stator windings 14 are loaded in the stator 11, the beam 15 is needed to be used to hold the stator windings 14 by a large contact area so as not to scratch an insulator enclosing the stator windings 14. On the other hand, the rotor 1 in the present invention is of a squirrel-cage type, so the rotor bar 4 is not electrically insulated. Therefore, the rotor bar 4 can be held directly by the stepped support, as illustrated in FIG. 1.

FIG. 2 is a graph showing a relationship between a flux pulsation ratio (vertical axis of the graph) and a ratio of a stator slot opening width to a gap length between a stator and a rotor (horizontal axis of the graph). As for an induction machine the stator 11 of which is of open slot type as in the first embodiment illustrated in FIG. 1, a ratio of the slot open width to a gap length between the stator and the rotor is generally about 3 to 6.5 and the flux pulsation ratio becomes as large as about 0.3 to 0.4. Accordingly, an electric power loss called the harmonic secondary copper loss, which occurs on a surface on the outer circumferential side of the rotor bar 4 due to the influence of the harmonic magnetic flux, tends to occupy a large percentage.

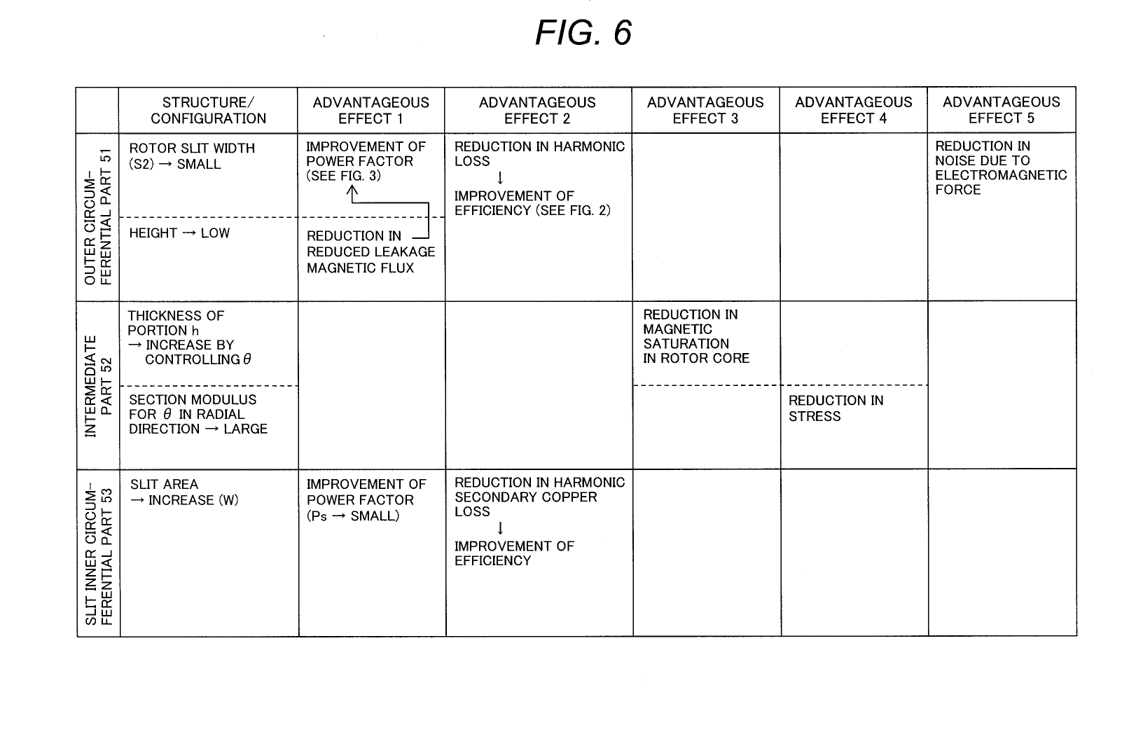

As an example of the first embodiment, the rotor slit 5 is distinguished into three parts, i.e., the slit outer circumferential part 51, slit intermediate part 52, and slit inner circumferential part 53 in this order from the outer circumferential side toward the inner circumferential side as illustrated in FIG. 1. A relationship between the role of each part and its advantageous effect will be described below. Meanwhile, there is summarized, in FIG. 6 in tabular form, a relationship between structure/configuration of each part (the slit outer circumferential part 51, slit intermediate part 52 and slit inner circumferential part 53) and an advantageous effect achieved by the each part.

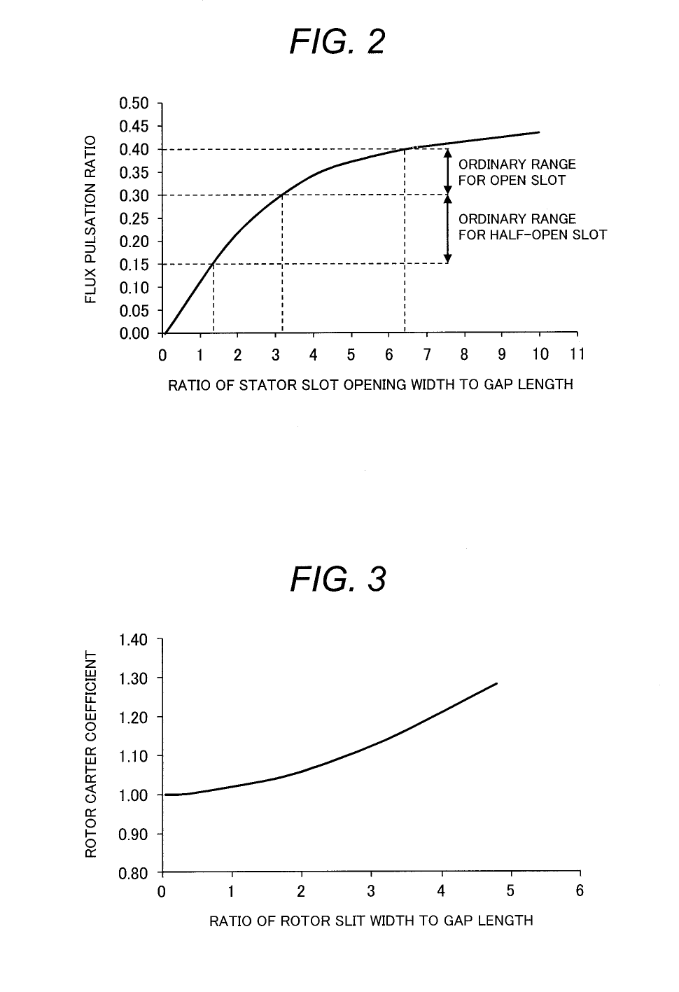

The structure/configuration of the slit outer circumferential part 51 contributes to improvement of power factor and reduction in harmonic loss in the stator 11. FIG. 3 is a graph showing a relationship between the rotor Carter coefficient and a ratio of a rotor slit width to a gap length between a stator and a rotor. From FIG. 3, it is revealed that the Carter coefficient can be reduced when the rotor slit width (a slit opening width) S2 is reduced of the slit outer circumferential part 51 while the gap length g indicated in FIG. 1 is kept constant. By reducing the Carter coefficient, a no-load current can be reduced, thereby making it possible to improve the power factor. In addition, as illustrated in FIG. 2, the flux pulsation can be reduced, making it possible to reduce the harmonic loss. When the harmonic loss is reduced, an electromagnetic force, which is one of noise generating factors, can be reduced, resulting in low noise.

The structure/configuration of the slit outer circumferential part 51 will be further described, focusing on a height of the slit outer circumferential part 51 in the radial direction of the rotor slit 5. The height is preferably approximately the same as the rotor slit width S2. This is because when the rotor slit width S2 of the slit outer circumferential part 51 is reduced, a magnetic flux is easily leaked, but the low height of the slit outer circumferential part 51 reduces leakage of the magnetic flux and improves the power factor. Meanwhile, even if the height of the slit outer circumferential part 51 is reduced to 0 (zero), by decreasing a width of the slit intermediate part 52 on its outer circumference side, the power factor can be improved and a low harmonic loss and low noise can be achieved by a reduction in the harmonic magnetic flux.

Next, there will be described regarding the slit intermediate part 52. The structure/configuration of the slit intermediate part 52 contributes to reduction in magnetic saturation and stress in the rotor core 2 adjacent to the slit outer circumferential part 51 and slit intermediate part 52.

First, a relationship with magnetic saturation will be described. As described above, the height of the slit outer circumferential part 51 is preferably low, but the rotor core 2 adjacent to the slit outer circumferential part 51 is prone to cause magnetic saturation due to the low height of the slit outer circumferential part 51. On the other hand, when a width of the slit intermediate part 52 is gradually increased toward a more inner circumferential position, a magnetic path for the magnetic flux in the circumference direction (a magnetic path height h illustrated in FIG. 1) can be expanded and then the magnetic saturation can be reduced.

Next, a relationship with stress will be described. For an induction machine used in a high-speed rotation area by the use of, e.g., an inverter, when teeth of the rotor core adjacent to the slit outer circumferential part 51 have a constant thickness, the teeth of the rotor core may be damaged due to stress of a centrifugal force exerted by the mass of the rotor core itself. In contrast, when the slit intermediate part 52 is provided, the section modulus for a force exerted in radial directions can be increased. Accordingly, the stress can be reduced and reliability in strength can also be improved. Furthermore, because a stress due to the centrifugal force of the rotor bar 4 is exerted on the rotor core 2 adjacent to the slit inner circumferential part 53, the stress exerted on the rotor core adjacent to the slit outer circumferential part 51 and slit intermediate part 52 can be reduced accordingly.

There will be described regarding the slit inner circumferential part 53. The structure/configuration of the slit inner circumferential part 53 contributes to reduction in harmonic loss (improvement of efficiency) and reduction in main magnetic flux leakage (improvement of the power factor). The ease with which the main magnetic flux leaks is represented as a leakage permeance ratio Ps by using the following Equation (1).

“Ps=(Height of rotor slit 5)/(Average width of rotor slit 5)=(Height of rotor slit 5)²/(Area of rotor slit 5) Equation (1).”

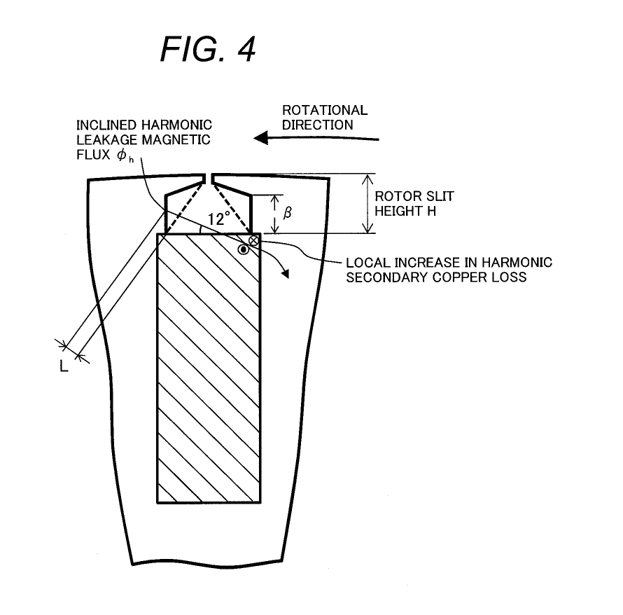

FIG. 4 is a schematic drawing showing an enlarged cross sectional view around a rotor slot, in which a case provided with a slit inner circumferential part and another case without the slit inner circumferential part are illustrated. Furthermore, a leakage magnetic flux of a harmonic component on the rotor slit is also illustrated in FIG. 4.

In FIG. 4, the structure/configuration indicated by the solid lines is a structure/configuration of the present invention. In this structure/configuration, an opening of the slit outer circumferential part 51 is narrowed; the width of the slit intermediate part 52 gradually expands; and the width of the slit inner circumferential part 53 is kept constant.

By contrast, in the structure/configuration indicated by the broken lines, the slit inner circumferential part 53 is not provided. That is, the rotor slit is composed of the slit outer circumferential part 51 and the slit intermediate part 52, in which the slit intermediate part 52 expands gradually from the slit outer circumferential part 51 to the surface of the rotor bar 4.

As is apparent from FIG. 4, while a height H of the rotor slit 5 from the surface of the rotor bar 4 is kept unchanged, by providing with a slit inner circumferential part 53 having a height p, an area of the rotor slit provided with the slit inner circumferential part 53 (shown by the solid lines) becomes larger than an area of the rotor slit without the slit inner circumferential part 53 (shown by the broken lines). As a result, the leakage permeance ratio Ps in Equation (1) can be reduced, enabling the power factor to be improved.

It was experimentally clarified by the inventors that an induction machine generates, in the rotor slit 5, a harmonic leakage magnetic flux which is inclined with respect to the circumferential direction due to the counteraction of an armature. In FIG. 4, this inclined harmonic leakage magnetic flux φh is illustrated, as mentioned above. Through the experiment, it was revealed that when the inclined harmonic leakage magnetic flux φh interlinks the outer circumferential surface of the rotor bar 4 on the delayed side in its rotational direction, a large harmonic secondary copper loss is locally generated.

On the other hand, when the slit inner circumferential part 53 is provided, a magnetic flux path, which penetrates the rotor bar 4 on the delayed side in its the rotational direction, can be prolonged by a length L in the rotor slit 5, enabling a magnetic resistance to increase through the prolonged path. Therefore, an amount by which the harmonic leakage magnetic flux φh interlinks the rotor bar 4 can be reduced, and efficiency can be improved by reduction in harmonic secondary copper loss.

Although, in the above descriptions, the rotor slit 5 has been distinguished into three parts, the slit outer circumferential part 51, slit intermediate part 52 and slit inner circumferential part 53, as an example for explaining advantageous effects in the first embodiment, this embodiment is not limited to this structure.

In the present invention, the width of the rotor slit 5 in the circumferential direction (especially, in the slit intermediate part 52) gradually increases from the outer circumferential side toward the inner circumferential side of the rotor slit 5. In addition, the rotor slit 5 may have a portion in which an increase rate in the width of the rotor slit 5 in the circumferential direction along the radial direction becomes small, as mentioned before.

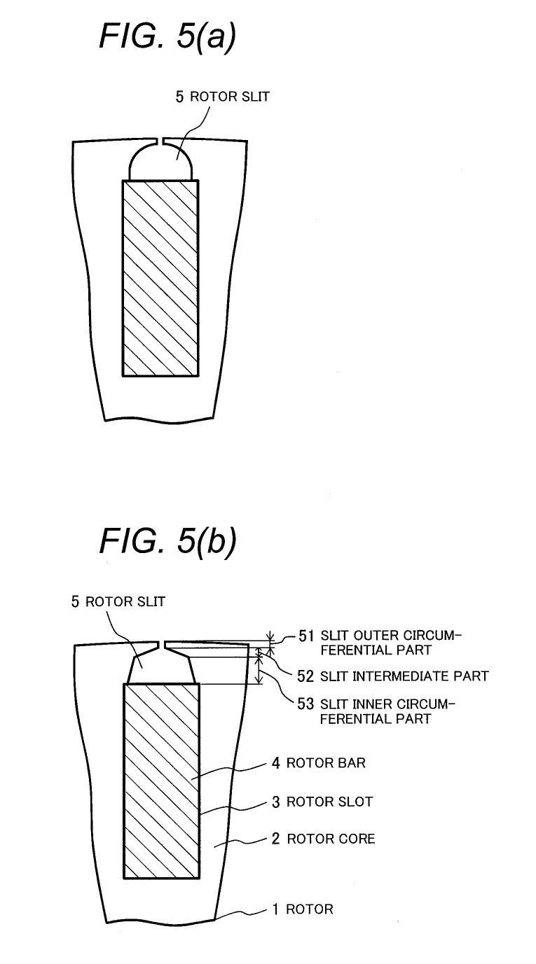

For example, the rotor slit 5 illustrated in FIGS. 5A and 5B are accepted. FIGS. 5A and 5B are schematic drawings showing an enlarged cross sectional view around a rotor slot, in which variations of the rotor slit shape are illustrated.

In the example in FIG. 5A, the rotor slit 5 is curved. In the example in FIG. 5B, the width of the slit inner circumferential part 53 of the rotor slit 5 in the circumferential direction is not constant. In other words, the width of the slit inner circumferential part 53 in the circumferential direction increases gradually along the radial direction at a smaller increase rate than the slit intermediate part 52.

As a result of using the structure/configuration in the first embodiment of the present invention described so far, additional advantageous effects are also obtained. These effects will be described below. See FIG. 6.

As for an axial-flow cooling type of induction machine, which is cooled by blowing air in the axial direction of the induction machine, the pressure gradient of the blown air is controlled by a flow resistance of the flow channel in the axial direction. Therefore, the amount of the blown air passing through the rotor slit 5 is determined dominantly by a cross sectional area of the rotor slit 5 in its axial direction. That is, when the structure/configuration in FIGS. 1, 5A and 5B is adopted, the cross sectional area of the rotor slit 5 formed as a hollow can be enlarged. Therefore, the amount of air passing through the rotor slit 5 is increased, enabling the rotor bar 4 to be efficiently cooled. When the cooling effect increases, a temperature rise of the rotor bar 4 and end ring 6 can be suppressed and an increase of the electric resistance of their conductors can be suppressed. As a result, the secondary copper loss can be reduced.

In addition, the axial air flow passing through the rotor slit 5 is changed into its radial direction by the end ring 6 and a frame of the induction machine, directing radial air flow toward the stator windings 14. That is, when the amount of air passing through the rotor slit 5 increases, the effect of cooling the stator windings 14 can be improved. Thus, a temperature rise of the stator windings 14 can be suppressed and a primary copper loss can be reduced.

As described above, in the present invention, because the increase of electric resistance of the conductors can be suppressed by efficient cooling, the primary copper loss and the secondary copper loss can be reduced, assuring improved efficiency.

If a magnetic flux density on the inner circumferential side of the rotor core 2 is sufficiently low, the heights of the slit intermediate part 52 and slit inner circumferential part 53 in their radial directions can be enlarged while the cross sectional area of the rotor bar 4 is left unchanged. In other words, the rotor bar 4 can be placed on a more inner circumference side. When the rotor bar 4 is placed on a more inner circumference side, the end ring 6 can be also placed on a more inner circumference side accordingly, i.e., the outer diameter of the end ring 6 can be smaller. When the outer diameter of the end ring 6 becomes smaller, the inner circumferential stress of the end ring 6 can be reduced.

Furthermore, when the outer diameter of the end ring 6 becomes smaller, the circumference length of the end ring 6 becomes shorter. Therefore, when a conductor cross sectional area is left unchanged, the electric resistance of the end ring 6 is also reduced, and efficiency can be improved due to reduction in the secondary copper loss of the end ring 6. Meanwhile, the end rings 6 are disposed at both ends of the rotor bars 4 and on the innermost circumferential side of the rotor bars 4, as described before.

In the above descriptions, the rotor bar 4 and end ring 6 are formed with copper and are soldered. However, the present invention is not limited thereto. For example, the rotor bar 4 and end ring 6 may be formed with aluminum or brass and be connected by friction stir welding or die-casting, as a variation. Even in such variations, the advantageous effects in the present invention can be obtained.

Also, in the above descriptions, the stator slot 13 has been of open slot type. However, the present invention is not limited thereto. Even if an induction machine utilizes a semi-closed slot or a magnetic beam, advantageous effects can be obtained, though being less when compared with an induction machine that uses an open slot.

In the present invention, when the rotor slit 5 is structured/configured as described above, the main magnetic flux and harmonic magnetic flux can be selectively separated, so a highly efficient induction machine with a high strength can be provided.

### Second Embodiment

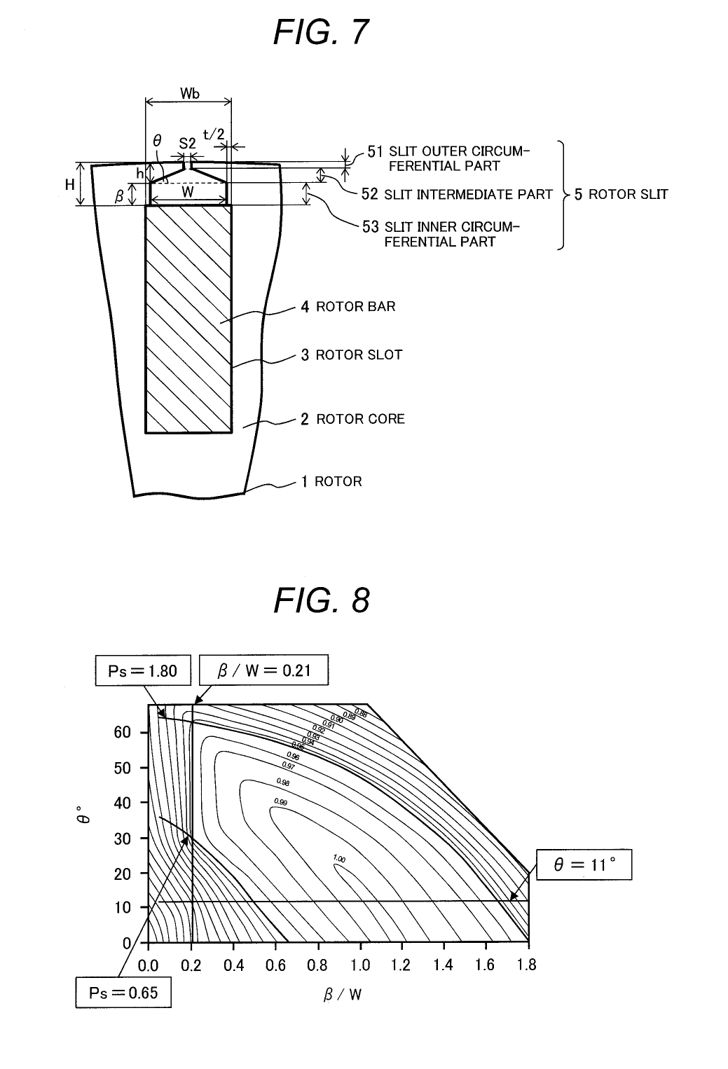

In a second embodiment of the present invention, dimensions of individual parts of the rotor slit 5 described in the first embodiment will be defined to obtain preferable advantageous effects. FIG. 7 is a schematic drawing showing an enlarged cross sectional view around a rotor slot of a squirrel-cage induction machine according to a second embodiment of the present invention. In FIG. 7, the dimensions of individual parts of the rotor slit 5 are indicated as symbols.

As shown in FIG. 7, an inclination angle formed by the slit intermediate part 52 with respect to the circumferential direction is denoted θ, the width of the slit inner circumferential part 53 at an innermost circumferential position in the circumferential direction is denoted W, the height of the slit inner circumferential part 53 in its radial direction is denoted β, the outer circumferential width of the rotor bar 4 in the circumferential direction is denoted Wb, and the width of a step, which is a difference between the outer circumferential widths of the slit inner circumferential part 53 and rotor bar 4, is denoted t (i.e., t=Wb−W, the width of the step on one side is t/2). The rotor slit width (the slit opening width) S2 of the slit outer circumferential part 51 and the height h (a total height) of the slit intermediate part 52 and slit outer circumferential part 51 in their radial directions in FIG. 7 are the same as in FIG. 1.

FIG. 8 shows an efficiency map of the induction machine for the dimensions defined in FIG. 7. In the efficiency map of FIG. 8, the horizontal axis of the efficiency map indicates a ratio of the height β of the slit inner circumferential part 53 in its radial direction to the width W of the slit inner circumferential part 53 at an innermost circumferential position in the circumferential direction. This ratio β/W is a so-called aspect ratio of the slit inner circumferential part 53. The vertical axis of the efficiency map indicates the inclination angle θ formed by the slit intermediate part 52. In FIG. 8, efficiencies are indicated as contour lines on a plane formed by the two axes. The leakage permeance ratio Ps of the rotor slit 5, which is calculated by Equation (1), is also indicated in FIG. 8.

With the efficient map of FIG. 8, an area with highly efficient contour lines can be defined with the aspect ratio β/W of the slit inner circumferential part 53, the inclination angle θ formed by the slit intermediate part 52, and the leakage permeance ratio Ps of the rotor slit 5. Specifically, in a range in which the leakage permeance ratio Ps is 0.65 to 1.80 and the aspect ratio β/W is 0.21 or more, the leakage permeance ratio Ps of the rotor slit 5 becomes preferable and a high efficiency is obtained.

A logical background behind the preferable result in the above numerical range and a relationship with an actual apparatus will be supplementally described below.

An induction machine with a large capacity of 1 to 10 MW will be assumed as an actual apparatus. With the large-capacity induction machine, the width W of the slit inner circumferential part 53 at an innermost circumferential position in the circumferential direction increases in proportion to the outer diameter of the rotor 1; W is generally about 5 mm or more. The rotor slit width S2 of the slit outer circumferential part 51 should be small as indicated in FIG. 3. In view of the operating life of a mold by which the slit outer circumferential part 51 is punched, however, the rotor slit width S2 should be about 1.5 mm. With the induction machine with a large capacity of 1 to 10 MW, therefore, S2/W becomes as small as 0.3 or less. Accordingly, the value of S2 does not so affect the height and area in Equation (1), so the ranges of Ps, β and W that can achieve a high efficiency are hardly affected by S2.

Next, there will be described regarding a range of the leakage permeance ratio “0.65≦Ps≦1.80”. In a region in which Ps is smaller than 0.65, which is below a lower limit, it means that the harmonic secondary copper loss is large in the total loss of the induction machine, so the efficiency is low. In this region in which Ps is less than 0.65, when β/W and θ are controlled to bring the leakage permeance ratio Ps of the rotor slit 5 close to 0.65, not only the main magnetic flux but also the harmonic magnetic flux become easy to leak, reducing the harmonic secondary copper loss and improving the efficiency. In a region satisfying 0.65≦Ps≦1.80, there are well balanced both an amount by which the harmonic secondary copper loss is reduced and an amount by which the primary and secondary copper losses of the fundamental wave components, which will be described later, are increased, so the efficiency becomes high and is almost constant.

On the other hand, in a region in which Ps is larger than 1.80, which is above an upper limit, the main magnetic flux becomes large and the power factor is thereby lowered, increasing the primary copper loss. In the case that the leakage permeance ratio Ps of the rotor slit 5 is large, it means that the height H of the rotor slit 5 is also large. In this situation, if the innermost circumferential position of the rotor bar 4 cannot be changed toward a more inner circumferential side, it leads that the cross sectional area of the rotor bar 4 is reduced, increasing the secondary copper loss of the fundamental wave component. When both the primary copper loss and the secondary copper loss of the fundamental component increase, the power factor and efficiency rapidly drop.

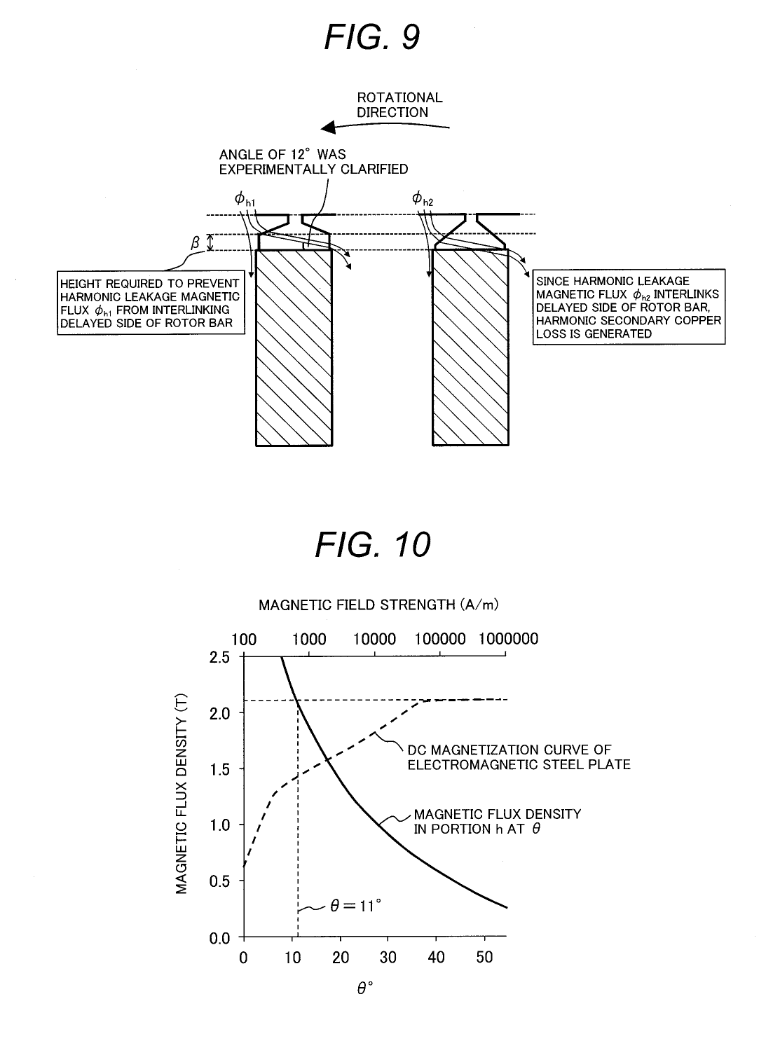

Next, there will be described regarding a case of β/W≧0.21. FIG. 9 is a schematic drawing showing an enlarged cross sectional view around rotor slots, in which different harmonic magnetic flux paths at different heights β of the slit inner circumferential part 53 are illustrated. As described in the first embodiment, it was revealed that the inclined harmonic leakage magnetic flux φh interlinks the delayed side of the rotor bar 4 in its rotational direction. In order to clarify the harmonic leakage magnetic flux φh, additional experiments were carried out on the induction machine in further detail. Through those experiments, it was revealed that the harmonic leakage magnetic flux φh is inclined at about 12° with respect to the circumferential direction.

The experimental result indicates that the harmonic leakage magnetic flux φh passes through the rotor slit 5 at an inclination angle of 12°, as illustrated on the left side of FIG. 9. Therefore, when the height β of the slit inner circumferential part 53 is determined so that the harmonic leakage magnetic flux φh has an inclination angle of 12° or more with respect to a tangent line drawn on the outer circumferential side of the rotor bar 4, the secondary copper loss of the harmonic leakage magnetic flux φh interlinking the rotor bar 4 can be reduced. In contrast, when the height β of the slit inner circumferential part 53 is insufficient as illustrated on the right side of FIG. 9, the magnetic path of the rotor slit 5 cannot be sufficiently prolonged, so the harmonic secondary copper loss cannot be adequately reduced.

Equation (2) below calculates the aspect ratio β/W of the slit inner circumferential part 53 that is needed to make the harmonic magnetic flux have an inclination angle of 12°. Herein, assuming that the width t, defined in FIG. 7, of the step of the inner circumferential part of the rotor slit 5 is adequately small when compared with the width W of the slit inner circumferential part 53, the outer circumference width Wb of the rotor bar 4 will be taken as W.

“β/W=tan⁻¹(π/180×12)=0.21 Equation (2).”

Meanwhile, from the efficient map of FIG. 8 as well, it can be confirmed that when the aspect ratio β/W of the slit inner circumferential part 53 is 0.21 or small, the efficiency rapidly drops.

Next, there will be described regarding a case in which the inclination angle θ of the slit intermediate part 52 is set to 11°. As described in the first embodiment, the slit intermediate part 52 is structured/configured so as to reduce magnetic saturation and stress in a portion at the height h (see FIG. 1) in a radial direction of the slit intermediate part 52 (the portion will be simply referred to below as the portion h).

The magnetic flux density in the portion h is proportional to: the fundamental wave component of an air-gap magnetic flux density; the flux pulsation ratio described in FIG. 2; and the outer diameter of the rotor core 2, and is inversely proportional to: number of the stator slots 13; and the size of the portion h. Since, in the second embodiment, the stator slot 13 is of open type, the flux pulsation ratio is prone to enlarge and the magnetic flux density in the portion h is prone to increase. FIG. 10 is a graph showing a relationship between the magnetic flux density in the portion h in FIG. 7 (on the vertical axis) and the inclination angle θ of the slit intermediate part 52 (on the lower horizontal axis), in which a DC magnetization curve of an electromagnetic steel sheet is also illustrated.

In FIG. 10, there is shown an example of a relationship between θ and the magnetic flux density in the portion h in an induction machine, in which θ is minimized at which the portion h reaches the saturation magnetic flux density. It is recognized from FIG. 10 that when θ is 11°, the portion h reaches the saturation magnetic flux density. When the portion h reaches the saturation magnetic flux density, the value of the Carter coefficient becomes large. This leads to a problem such that the no-load current increases and the power factor is reduced. In order to overcome the problem, it is preferable that θ is set to 11° or more, thereby the portion h becomes less likely to reach the magnetic flux saturation and a drop in power factor can be prevented.

As described above, θ to structure/configure the slit intermediate part 52 is required to be 11° or more, from the viewpoint of the magnetic flux saturation.

### Third Embodiment

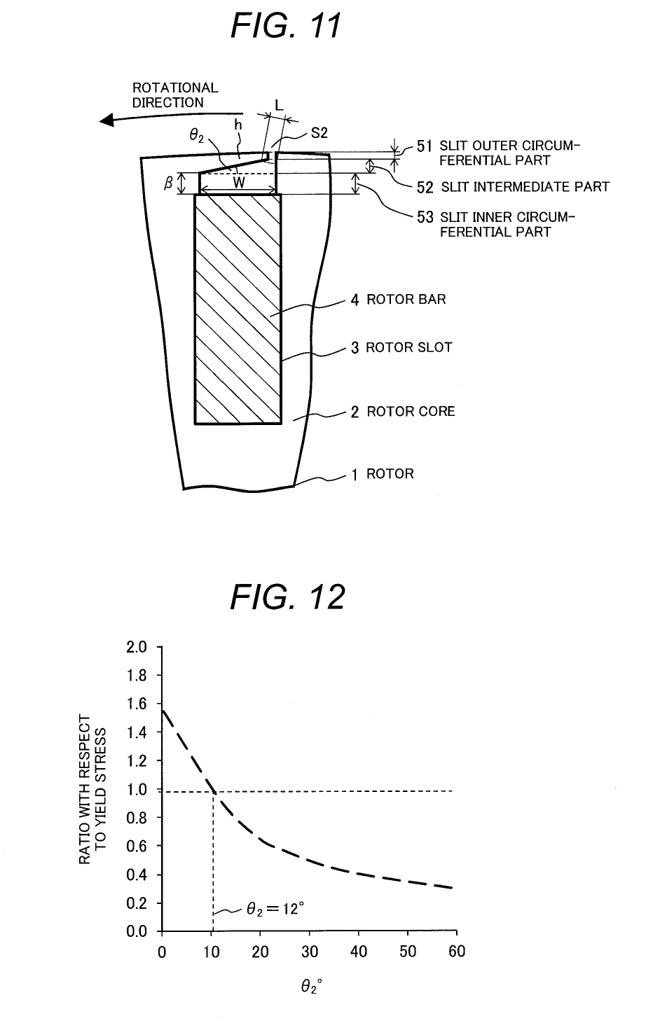

There will be described regarding a third embodiment of the present invention. FIG. 11 is a schematic drawing showing an enlarged cross sectional view around a rotor slot of an induction machine according to a third embodiment. As shown in FIG. 11, an induction machine of the third embodiment differs from that of the first embodiment in which the slit opening (the rotor slit width S2) of the slit outer circumferential part 51 is shifted toward the delayed side in the rotational direction of the rotor 1, and in which the delayed sides of the slit outer circumferential part 51, slit intermediate part 52, and slit inner circumferential part 53 are aligned on a straight line.

When, in the third embodiment, a preferable range is obtained from the efficiency map of FIG. 8, an inclination angle θ₂ formed by the slit intermediate part 52 in the circumferential direction on the advanced side in the rotational direction of the rotor 1 is represented as in the following Equation (3) by using θ in FIG. 8.

“θ₂=tan⁻¹((tan θ)/2) Equation (3).”

Because the slit opening (the rotor slit width S2) of the slit outer circumferential part 51 is shifted toward the delayed side, the harmonic magnetic flux in the third embodiment can be leaked at a position closer to the delayed side than that in the first embodiment, so the harmonic secondary copper loss generated on the delayed side of the rotor bar 4 can be reduced. Thus, a highly efficient induction machine can be provided.

Herein, in the third embodiment the lengths of the teeth on the surface of the rotor core 2 in the circumferential direction are prolonged than those in the first embodiment. Therefore, it is necessary to consider stress exerted by the mass of the rotor core 2 itself. Of the stress exerted by the mass of the rotor core 2 itself, the stress exerted on the teeth of the rotor core 2 due to the centrifugal force increases with the square of the rotational speed and increases in proportion to a radius of the rotor 1.

For example, in the case of an induction machine, with a large capacity of 1 to 10 MW, that is driven in a high-speed region (e.g., 15,000 min⁻¹) by the use of, e.g., an inverter, the stress exerted on the portion h due to the centrifugal force of the rotor 1 should be considered. FIG. 12 is a graph showing a relationship between the inclination angle θ₂ described in FIG. 11 and a ratio of a stress due to the centrifugal force on the portion h to a yield stress of the electromagnetic steel configuring the rotor core 2. In FIG. 12, there is shown an example of a relationship between θ₂ and a ratio of the stress exerted on the portion h to the yield stress of the rotor core 2, in which θ₂ is minimized at which the stress due to the centrifugal force reaches the yield stress.

It is recognized from FIG. 12 that when θ₂ is set to 12° or more, the stress exerted on the portion h caused by the centrifugal force can be suppressed below the yield stress of the rotor core 2. Then, a highly reliable induction machine can be provided.

### Fourth Embodiment

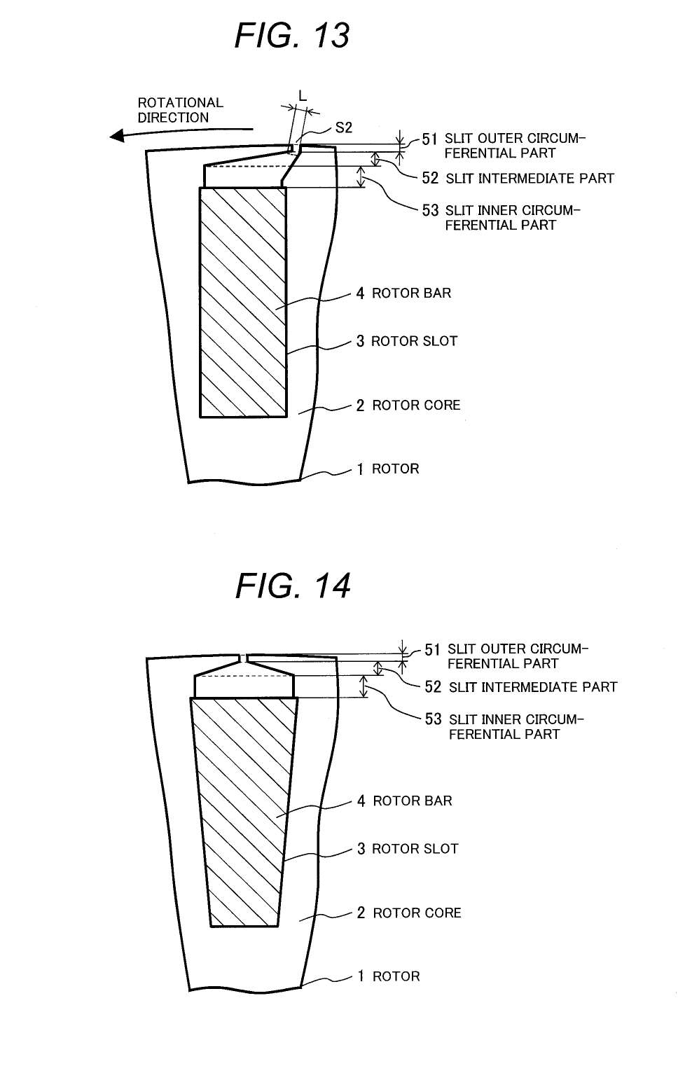

There will be described regarding a fourth embodiment of the present invention. FIG. 13 is a schematic drawing showing an enlarged cross sectional view around a rotor slot of an induction machine according to a fourth embodiment. As shown in FIG. 13, in an induction machine of the fourth embodiment, the slit opening (the rotor slit width S2) of the slit outer circumferential part 51 is shifted further to the delayed side in the rotational direction of the rotor 1 than in that of the third embodiment. Because of it, a magnetic path length L of the slit intermediate part 52 can be made shorter than L in the third embodiment. Accordingly, harmonic magnetic flux leakage concentrating on the surface of the rotor 1 can be increased, enabling the harmonic secondary copper loss to be reduced. Thus, a highly reliable induction machine can be provided.

### Fifth Embodiment

There will be described regarding a fifth embodiment of the present invention. FIG. 14 is a schematic drawing showing an enlarged cross sectional view around a rotor slot of an induction machine according to a fifth embodiment. As shown in FIG. 14, an induction machine of the fifth embodiment differs from that of the first embodiment in which the width of the rotor bar 4 on the outer circumferential side is larger than the width of the rotor bar 4 on the inner circumferential side.

In this structure/configuration, when an average width of the rotor bar 4 is the same as that in the first embodiment, a difference between the widths of the slit outer circumferential part 51 and slit inner circumferential part 53 in the circumferential direction can be made larger than those in the first embodiment. In other words, it can be considered that the magnetic flux is likely to leak on the outer circumferential side of the rotor slit 5 but is less likely to leak on the inner circumferential side of the rotor slit 5. Accordingly, the harmonic magnetic flux leakage concentrating on the surface of the rotor 1 can be increased with the main magnetic flux leakage suppressed. Thus, the harmonic secondary copper loss can be reduced and efficiency can be improved.

### Sixth Embodiment

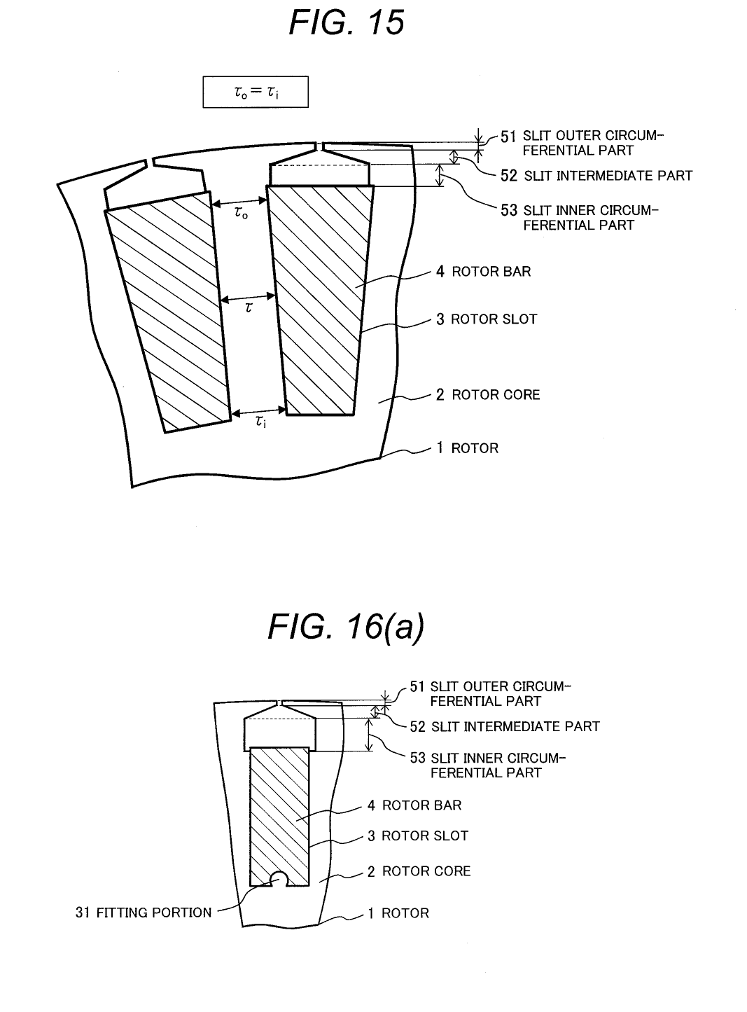

There will be described regarding a sixth embodiment of the present invention. FIG. 15 is a schematic drawing showing an enlarged cross sectional view around a rotor slot of an induction machine according to a sixth embodiment of the present invention. As shown in FIG. 15, an induction machine of the sixth embodiment differs from that of the fifth embodiment in which a width τ of the rotor core 2 sandwiched between two adjacent rotor slots 3 in the circumferential direction is constant from the innermost circumference side toward the outermost circumference side of the rotor slot 3.

In other words, a width τₒ of the rotor core 2 in the circumferential direction at the outermost circumferential positions of the two adjacent rotor slots 3 is almost the same as a width τᵢ of the rotor core 2 in the circumferential direction at the innermost circumferential positions of the two adjacent rotor slots 3. In this structure/configuration of this embodiment, unlike in that of the fifth embodiment, a difference between a high magnetic flux density and a low magnetic flux density, which have been generated in the rotor core 2 sandwiched between two adjacent rotor slots 3 in the radial direction of the rotor core 2 is eliminated. That is, the magnetic flux density in the rotor core 2 is evened. Thus, a no-load current is reduced, making it possible to improve the power factor.

### Seventh Embodiment

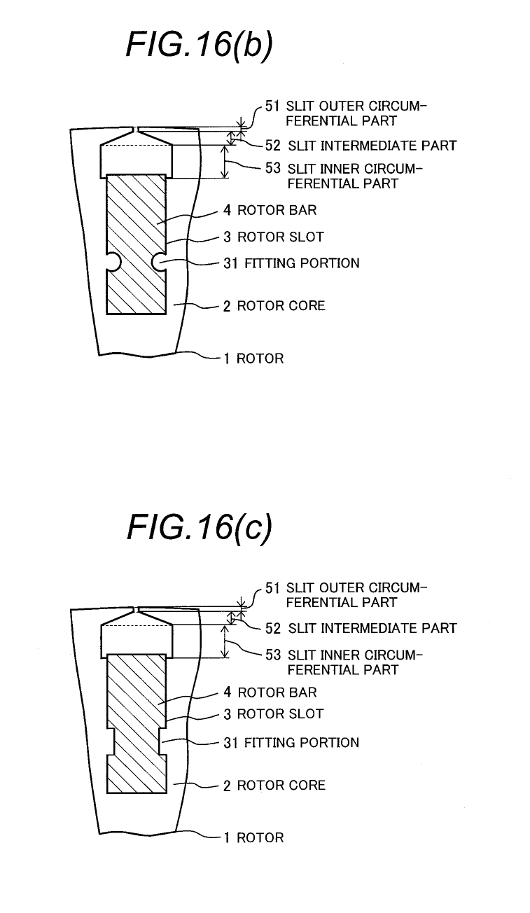

There will be described regarding a seventh embodiment of the present invention. FIGS. 16A to 16C are schematic drawings showing exemplary enlarged cross sectional views around a rotor slot of an induction machine according to a seventh embodiment of the present invention. First, as a prerequisite for an induction machine of the seventh embodiment, it is assumed that the stator 11 of the induction machine of this embodiment is the same as that in the first embodiment. For example, the stator slot 13 of this embodiment is an open slot in which the stator windings 14 are secured to the stator core 12 by the beam 15 fitted to the groove in the stator slot 13.

Furthermore, as in the first embodiment, in a plurality of rotor slits 5 formed adjacent to a plurality of rotor slots 3, the plurality of rotor slits 5 being closer to the outer circumference of the rotor core 2 than the plurality of rotor slots 3 being. Each of the rotor slits 5 is formed as a hollow. The rotor slit 5 is formed so that its shape in the cross section is distinguished into three parts of the slit inner circumferential part 53 in contact with the outer circumferential surface of the rotor bar 4, the slit outer circumferential part 51 facing the stator 11, and the slit intermediate part 52 disposed between the slit inner circumferential part 53 and the slit outer circumferential part 51.

The width of the slit inner circumferential part 53 in the circumferential direction is larger than the width of the slit outer circumferential part 51 in the circumferential direction. The width of the slit intermediate part 52 in the circumferential direction increases gradually from the outer side toward the inner side in the radial direction of the rotor slit 5.

Under the above assumption, in the seventh embodiment, at least one fitting portion 31 (e.g., a pair of protrusion and groove) is formed on each rotor slot 3 of the rotor core 2. Due to this fitting portion 31, the seventh embodiment differs from the other embodiments in which the width of the slit inner circumferential part 53 in the circumferential direction can be equal to or larger than the width of the outer circumferential surface of the rotor bar 4 in the circumferential direction. However, the width of the slit inner circumferential part 53 in the circumferential direction is such that even if it is larger than the width of the rotor bar 4 in the circumferential direction, the rotor core 2 does not cause too much magnetic saturation.

Specifically, FIG. 16A illustrates an example in which the fitting portion 31 is formed in an arc shape on the innermost circumferential surface of the rotor slot 3. FIG. 16B illustrates another example in which the fitting portion 31 is formed in an arc shape on surfaces of both sides in the circumferential direction of the rotor slot 3. FIG. 16C illustrates still another example in which the fitting portion 31 is formed in a rectangular shape on surfaces of both sides in the circumferential direction of the rotor slot 3. In all these examples, the width of the slit inner circumferential part 53 in the circumferential direction is larger than the width of the outer circumferential surface of the rotor bar 4 in the circumferential direction.

In these structures/configurations of this embodiment, a difference between the widths of the slit outer circumferential part 51 and slit inner circumferential part 53 in the circumferential direction can be made larger than in those of the fifth embodiment. In other words, it can be considered that the magnetic flux is likely to leak on the outer circumferential side of the rotor slit 5 but is less likely to leak on the inner outer circumferential side of the rotor slit 5. Accordingly, the harmonic magnetic flux leakage concentrating on the surface of the rotor 1 can be increased with the main magnetic flux leakage suppressed. Thus, the harmonic secondary copper loss can be reduced and efficiency can be improved.

### Eighth Embodiment

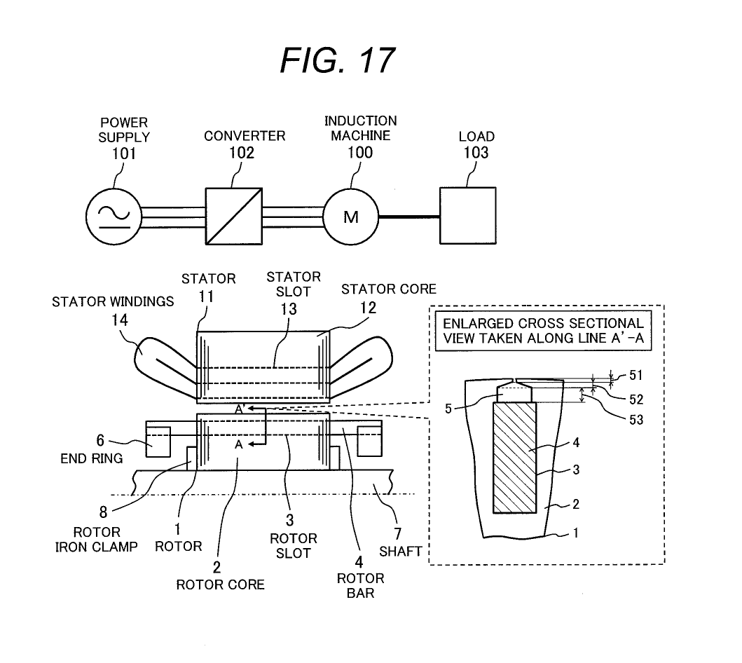

There will be described regarding an eighth embodiment of the present invention. In the induction machines described above, there is a possibility to generate a problem in which because an improved power factor increases a starting current, a power supply capacity must be increased to allow for this increase in the starting current. To overcome this possible problem, there is a preferable example of an induction machine driving system illustrated in FIG. 17.

FIG. 17 is a schematic drawing showing an induction machine driving system according to the present invention, accompanying with schematic drawings of a longitudinal sectional view in the axial direction of an induction machine and an enlarged cross sectional view thereof taken along line A-A′. As shown in FIG. 17, the induction machine driving system comprises an induction machine 100, a power supply 101 and a converter 102 such as an inverter, in which the converter 102 is disposed between and connected to the induction machine 100 and the power supply 101. A load 103 is driven by the induction machine 100. In this induction machine driving system, there is arisen no problem because a soft start in which a voltage and a frequency are controlled is possible.

When electric power is supplied through the converter 102 such as an inverter to the induction machine 100, a harmonic loss is prone to be generated according to a carrier frequency. However, the induction machine of the present invention can reduce the harmonic loss as described before, so efficiency can be further improved.

Furthermore, even if the induction machine is used in a high-speed rotation region by the use of an inverter etc., the stress to the rotor 1 can be reduced due to the advantageous effects provided by the slit intermediate part 52 as described in the first and second embodiments. Meanwhile, although the induction machine driving system in FIG. 17 is driven by a three-phase, even if electric power is supplied from a single-phase power supply or a DC power supply, the same advantageous effects as described before can be obtained.

### Ninth Embodiment

There will be described regarding a ninth embodiment of the present invention. Induction machines according to the present invention can be used in, for example, a pump system in which an induction machine drives a compressor or the like, a drilling system in which an induction machine drives a drill or another machine intended for excavation, a chip system in which an induction machine drives a mill or another machine intended for cutting chips, and a fan system in which an induction machine drives a fan.

If an induction machine driving system is specialized to improve characteristics only in one rotational direction, characteristics in the other rotational direction may be sacrificed. Even in this case, it is possible to increase the system efficiency depending on the way in which the system is used (depending on the load in a rotational direction and the usage time). In an exemplary case, in which the induction machine is mainly used in driving only in one rotational direction, when the asymmetric structure/configuration described in the third or fourth embodiment is used, a highly efficient induction machine driving system specialized only in one rotational direction can be provided.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An induction machine including a squirrel-cage rotor, the squirrel-cage rotor comprising:
a rotor core;
a plurality of rotor slots, each of the rotor slots being formed on the rotor core so as to extend along an axial direction of the rotor core and being aligned in a circumferential direction of the rotor core at a predetermined interval on an outer circumferential side of the rotor core;
a plurality of rotor bars, each of the rotor bars being inserted into one of the plurality of rotor slots; and
a plurality of rotor slits formed adjacent to the plurality of rotor slots in a redial direction of the rotor core, the plurality of rotor slits being closer to an outer circumference of the rotor core than the plurality of rotor slots being, wherein:
each of the rotor slits is formed as a hollow;
each of the rotor slit has a region in which a width in the circumferential direction of the region increases from an outer circumferential side toward an inner circumferential side; and
a width in the circumferential direction of the each rotor slit on an innermost circumferential side is larger than a width in the circumferential direction of the each rotor slit on an outermost circumferential side, and is smaller than a width in the circumferential direction of an outermost circumferential surface of each of the rotor bars.

2. The induction machine according to claim 1, wherein the each rotor slit has another region in which an increase rate in a width in the circumferential direction of the another region along the radial direction becomes small, the another region following the region in which the width in the circumferential direction of the region increases from the outer circumferential side toward the inner circumferential side.

3. The induction machine according to claim 1, wherein the width of the outermost circumferential surface of the each rotor bar is larger than a width of an innermost circumferential surface of the each rotor bar.

4. The induction machine according to claim 3, wherein a width in the circumferential direction of the rotor core sandwiched between two adjacent rotor slots is constant from the outer circumference side toward outer the inner circumference side.

5. The induction machine according to claim 1, wherein a slit opening formed in the each rotor slit, the slit opening being positioned at an outermost circumference of the each rotor slit, is shifted toward a delayed side in a rotational direction of the rotor within the width of the outermost circumferential surface of the each rotor bar.

6. The induction machine according to claim 1, wherein: a slit opening formed in the each rotor slit, the slit opening being positioned at an outermost circumference of the each rotor slit, is shifted toward a delayed side in a rotational direction of the rotor; and
a delayed side in the rotational direction of the slit opening is positioned toward the delayed side beyond the width of the outermost circumferential surface of the each rotor bar.

7. The induction machine according to claim 5, wherein the induction machine is applied to a drilling system that has a drill for which a driving force on one direction is required.

8. An induction machine including a squirrel-cage rotor, the squirrel-cage rotor comprising:
a rotor core;
a plurality of rotor slots, each of the rotor slots being formed on the rotor core so as to extend along an axial direction of the rotor core and being aligned in a circumferential direction of the rotor core at a predetermined interval on an outer circumferential side of the rotor core;
a plurality of rotor bars, each of the rotor bars being inserted into one of the plurality of rotor slots; and
a plurality of rotor slits formed adjacent to the plurality of rotor slots in a redial direction of the rotor core, the plurality of rotor slits being closer to an outer circumference of the rotor core than the plurality of rotor slots being, wherein:
each of the rotor slits is formed as a hollow; and
each of the rotor slits is formed such that a cross sectional shape thereof is distinguished into three parts of: a slit outer circumferential part positioned at an outermost circumference of the rotor core, in which a slit opening is formed; a slit intermediate part adjacent to the slit outer circumferential part, in which a width in the circumferential direction of the each rotor slit increases from an outer circumference side toward an inner circumference side; and a slit inner circumferential part adjacent to the slit intermediate part, in which an increase rate in the width in the circumferential direction along the radial direction of the slit inner circumferential part is smaller than that of the slit inner circumferential part.

9. The induction machine according to claim 8, wherein denoting a width in the circumferential direction of the slit opening in the slit outer circumferential part as S2, denoting a width in the circumferential direction of the slit inner circumferential part at an innermost circumferential position as W, and denoting an angle of the slit intermediate part with respect to the circumferential direction as 0, a relationship between S2 and W is S2/W≦0.3, and θ≧11°.

10. The induction machine according to claim 8, wherein denoting a width in the circumferential direction of the slit opening in the slit outer circumferential part as S2, denoting a width in the circumferential direction of the slit inner circumferential part at an innermost circumferential position as W, and denoting an angle of the slit intermediate part with respect to the circumferential direction as θ, a relationship between S2 and W is S2/W≦0.3, and θ≧12°.

11. The induction machine according to claim 8, wherein denoting a width in the circumferential direction of the slit opening in the slit outer circumferential part as S2, denoting a width in the circumferential direction of the slit inner circumferential part at an innermost circumferential position as W, and denoting a height in the radial direction of the slit inner circumferential part as β, a relationship between S2 and W is S2/W≦0.3, and a relationship between β and W is β/W≧0.21.

12. The induction machine according to claim 8, wherein denoting a width in the circumferential direction of the slit opening in the slit outer circumferential part as S2, denoting a width in the circumferential direction of the slit inner circumferential part at an innermost circumferential position as W, denoting a height in the radial direction of the each rotor slit as H, and denoting an area of the each rotor slit as S, a relationship between S2 and W is S2/W≦0.3, and a relationship between H and S is H²/S≧0.65.

13. The induction machine according to claim 8, wherein denoting a width in the circumferential direction of the slit opening in the slit outer circumferential part as S2, denoting a width in the circumferential direction of the slit inner circumferential part at an innermost circumferential position as W, denoting a height in the radial direction of the each rotor slit as H, and denoting an area of the each rotor slit as S, a relationship between S2 and W is S2/W≦0.3, and a relationship between H and S is H²/S≦1.80.

14. The induction machine according to claim 8, wherein denoting a height in the radial direction of the slit inner circumferential part as β, denoting a width in the circumferential direction of the slit inner circumferential part at an innermost circumferential position as W, and denoting an angle of the slit intermediate part with respect to the circumferential direction as θ, a relationship between β and W is β/W≦0.21, and θ≧11°.

15. The induction machine according to claim 8, wherein denoting a height in the radial direction of the slit inner circumferential part as β, denoting a width in the circumferential direction of the slit inner circumferential part at an innermost circumferential position as W, denoting an angle of the slit intermediate part with respect to the circumferential direction as θ, denoting a height in the radial direction of the each rotor slit as H, and denoting an area of the each rotor slit as S, a relationship between β and W is β/W≧0.21, θ≧11°, and a relationship between H and S is 0.65≦H²/S≦1.80.

16. The induction machine according to claim 1, wherein the induction machine is driven by a voltage supplied from an AC power supply or a DC power supply, the voltage being converted by an inverter or a converter before being supplied to the induction machine.

17. The induction machine according to claim 8, wherein the induction machine is driven by a voltage supplied from an AC power supply or a DC power supply, the voltage being converted by an inverter or a converter before being supplied to the induction machine.

18. The induction machine according to claim 6, wherein the induction machine is applied to a drilling system that has a drill for which a driving force on one direction is required.

19. An induction machine including a squirrel-cage rotor, the squirrel-cage rotor comprising:
a rotor core;
a plurality of rotor slots, each of the rotor slots being formed on the rotor core so as to extend along an axial direction of the rotor core and being aligned in a circumferential direction of the rotor core at a predetermined interval on an outer circumferential side of the rotor core;
a plurality of rotor bars, each of the rotor bars being inserted into one of the plurality of rotor slots; and
a plurality of rotor slits formed adjacent to the plurality of rotor slots, the plurality of rotor slits being closer to an outer circumference of the rotor core than the plurality of rotor slots being, wherein:
each of the rotor slits is formed as a hollow;
each of the rotor slits has a region in which a circumferential width of the region increases from an outer circumferential side toward an inner circumferential side;
a circumferential width of the each rotor slit on an innermost circumferential side is larger than a circumferential width of the each rotor slit on an outermost circumferential side, and is larger than an outermost circumferential width of each of the rotor bars; and
at least one fitting portion to hold the rotor bar is formed on each of the rotor slot.
